(19) United States
(12) Patent Application Publication
(10) Pub. No.: US 2026/0227060 A1
(43) Pub. Date: Aug. 6, 2026

(54) A lamp with active cooling

(71) Applicant: SIGNIFY HOLDING B.V., EINDHOVEN (NL)

(72) Inventors: ZHI HONG, SHANGHAI (CN); LAN DENG, SHANGHAI (CN); FAN ZHENG, SHANGHAI (CN); ZHONG WANG, SHANGHAI (CN)

(21) Appl. No.: 19/148,187

(22) PCT Filed: Jan. 15, 2024
(86) PCT No.: PCT/EP2024/050811

§ 371 Date: Jul. 15, 2025

(30) Foreign Application Priority Data
Jan. 16, 2023 (WO) PCT/CN2023/072421
May 16, 2023 (EP) 23173642.2

(51) Int. Cl. F21V 29/77; F21V 29/503; F21V 29/67

(52) U.S. Cl. CPC F21V 29/777; F21V 29/503; F21V 29/677

(57) ABSTRACT

A lamp with active cooling in the form of an airflow produced by a fan. A volume of space is surrounded or delimited by a heatsink. The volume of space is closed or capped with a covering element, to prevent/reduce the airflow from the fan element into the volume of space.

### FIELD OF THE INVENTION

The present invention relates to the field of lighting, and in particular to lamps with active cooling elements.

### BACKGROUND OF THE INVENTION

There is an ongoing desire to improve artificial lighting, which are used to provide artificial light in a wide variety of environments, such as in domestic, industrial and/or public settings.

One type of lamp that is used to provide artificial lighting is a lamp with an active cooling element, such as a fan. This is particularly important for lamps that are resource-intensive and for which it is therefore important to avoid overheating. Typically, the fan is configured to direct air towards the lighting element, or a heatsink thereof, for the purposes of cooling.

There is an ongoing desire to improve the effectiveness of cooling such lamps.

### SUMMARY OF THE INVENTION

The invention is defined by the claims.

According to examples in accordance with an aspect of the invention, there is provided a lamp comprising a light emitting element; a heatsink, a fan element and a covering element. The heatsink is thermally coupled to the light emitting element and configured to surround a volume of space. The fan element is configured to produce an airflow and direct the airflow towards the heatsink. The covering element is configured to cover the volume of space surrounded by the heatsink so as to close the volume of space at an end proximate to the fan element.

The present disclosure provides a lamp with active cooling in the form of an airflow produced by a fan. A volume of space is surrounded or delimited by a heatsink. The volume of space is closed or capped with a covering element, to prevent/reduce the airflow from the fan element into the volume of space. This increases the amount of air or gas that is directed towards the heatsink, thereby increasing the pressure of the airflow through the heatsink. This provides a lamp with more effective heat dissipation (e.g., compared to a device without a capped/closed volume of space).

In some examples, the lamp further comprises a coupling element configured to couple the fan element to the heatsink.

In some examples, the fan element comprises a fan, a fan housing and a fan coupling element. The fan is configured to produce airflow. The fan housing is configured to house the fan. The fan coupling element is configured to couple the fan housing to the coupling element.

In some examples, the fan coupling element comprises one or more protrusions configured to extend towards the heatsink and the coupling element couples to the fan coupling element at each of the one or more protrusions.

In some examples, the coupling element is configured to couple to the fan coupling element via one or more screws or bolts.

The volume of space may be used, for instance, for carrying electrical connectors, wires, control circuitry, driving circuitry and/or power circuitry. This allows for a more compact lamp. The volume of space also separates to sides of the heatsink from one another, to increase an exposed surface area of the heatsink for more effective heat dissipation. In some examples, the volume of space is cylindrical.

The covering element may be configured to prevent airflow, directed from the fan element, from entering the volume of space at the end proximate to the fan element.

In some examples, the heatsink comprises a polygon cylinder (i.e., a prism) configured to surround the volume of space. The cross-sectional shape of the polygon cylinder or prism may be any regular or irregular shape.

The polygon cylinder may be an annular cylinder, more specifically, a cylinder with an annular or ring-shaped cross section. Conceptually, the annular cylinder would thereby bound a cylindrical volume of space (i.e., a space having a circular cross-section).

In some examples, the lamp further comprises an air outlet from which the airflow, produced by the fan element, escapes the lamp. In this embodiment, the heatsink is positioned between the air outlet and the fan element.

In some examples, the heatsink is configured to surround an axis of the volume of space. The length of the heatsink, measured in a direction parallel to the axis of the volume of space, may be greater than the width of the heatsink, measured in a direction perpendicular to the axis of the volume of space.

The heatsink may comprise a plurality of fins for dissipating heat into the airflow.

In some examples, the heatsink comprises at least one recess; and the light emitting element is coupled to the heatsink so as to cover at least a portion of the at least one recess.

In some examples, the fan element comprises an air intake through which air is drawn by the fan element to produce the airflow.

In some examples, the light emitting element is configured to attach to the heatsink.

In some examples, the lamp further comprises a lamp base for mounting the lamp to a socket. The lamp base is located at a first end of the heatsink and the fan element is located at a second end of the heatsink, wherein the second end is opposite to the first end.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a cross-sectional view of a lamp according to an embodiment;

FIG. 2 is an enhanced cross-sectional view of a portion of the lamp;

FIG. 3 is a top-down cross-sectional view of the lamp;

FIG. 4 illustrates a coupling element and a fan coupling element;

FIG. 5 provides a view of an assembled configuration of the coupling element and fan coupling element;

FIG. 6 provides a view of the lamp;

FIG. 7 provides an exploded view of a lamp according to an embodiment;

FIG. 8 provides an external view;

FIG. 9 illustrates a technique for assembling a heatsink and light emitting element;

FIG. 10 illustrates a heatsink and light emitting element after assembly; and

FIG. 11 illustrates an air outlet arrangement.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a lamp comprising a light emitting element; a heatsink, a fan element and a covering element. The heatsink is thermally coupled to the light emitting element and configured to surround a volume of space. The fan element is configured to produce an airflow and direct the airflow towards the heatsink. Furthermore, the covering element is configured to cover the volume of space surrounded by the heatsink so as to close the volume of space at an end proximate to the fan element.

A herein proposed approach is based on a lamp with active cooling in the form of an airflow produced by a fan. A volume of space is surrounded or delimited by a heatsink. The volume of space is closed or capped with a covering element, to prevent/reduce the airflow from the fan element into the volume of space. This increases the amount of air or gas that is directed towards the heatsink, thereby increasing the pressure of the airflow through the heatsink. This provides a lamp with more effective heat dissipation (e.g., compared to a device without a capped/closed volume of space).

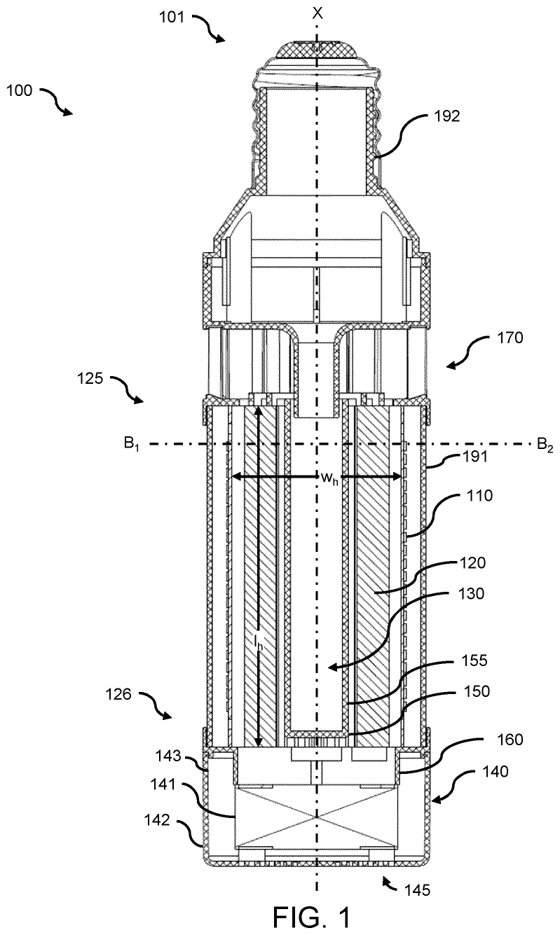

FIG. 1 illustrates a cross-sectional view of the lamp 100. The lamp 100 comprises a light emitting element 110, a heatsink 120, a fan element 140 and a covering element 150. The covering element 150 is configured to cover the volume of space surrounded by the heatsink so as to close the volume of space at an end proximate to the fan element.

For ease of explanation, FIG. 1 also illustrates an axis X. The axis X is positioned to align with a central axis of the lamp 100. More particularly, the axis X is configured to be perpendicular with a radial or diametric axis of the lamp 100.

FIG. 1 further defines a plane B1-B2, normal to the axis X and intersecting the heatsink radially.

The light emitting element 110 is configured to generate light. Examples of suitable light emitting elements are well known in the art, and include one or more light emitting diodes (LEDS). A light emitting element 110 will produce heat as a byproduct of generating light.

The heatsink 120 is thermally coupled to the light emitting element and configured to surround a volume of space 130. The heatsink is configured to dissipate heat generated by the light emitting element 110. The heatsink is configured to surround, delimit or encircle a volume of space 130. This advantageously improves the heat dissipation performed by the heatsink, by the volume of space providing an air gap between different parts/portions of the heatsink (e.g., rather than forming as a block), increasing its effective volume to surface area ratio.

The volume of space thereby increases an exposed surface area of the heatsink for more effective heat dissipation. Furthermore, the volume of space 130 may be configured to receive further components. In particular, the volume of space may be used, for instance, for carrying electrical connectors, wires, control circuitry, driving circuitry and/or power circuitry. This allows for a more compact lamp.

To improve the heat dissipation by the heatsink 120, a fan element 140 is configured to produce an airflow 200 that passes through or over the heatsink. The airflow 200 thereby carries heat away from the heatsink, to thereby improve the dissipation of heat away from the light emitting element 110, via the heatsink 120.

More particularly, the fan element 140 is configured to move external air (i.e., air from outside of the lamp 100) into the lamp and towards the heatsink 120 in the form of an airflow 200. Heat carried by the heatsink 120 is dissipated into this airflow 200, which then exits the lamp. In this way, the fan element provides active cooling of the light emitting element 110, and thereby the overall lamp 100.

The air may enter the lamp 100 (controlled by the fan element 140) via one or more air intakes 145 (alternatively labelled one or more air inlets) and exit the lamp 100 via one or more air outlets 170. It will be clear that the heatsink 120 is positioned between the air intake(s) 145 and the air outlet(s) 170. Thus, the air inlet(s) 145 is/are positioned at one end 126 of the heatsink 120, with the air outlet(s) 170 being positioned at another end 125 of the heatsink 120.

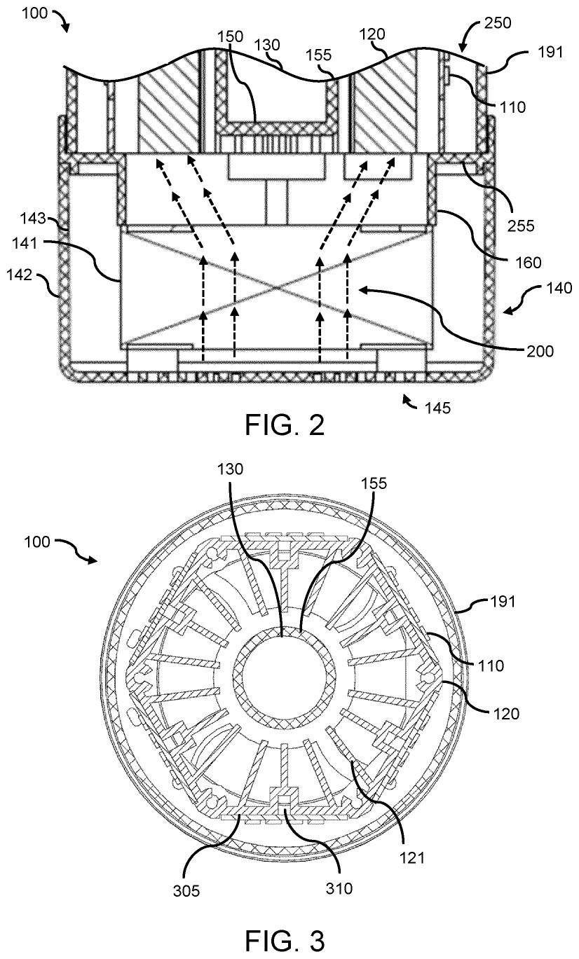

FIG. 2 is an enhanced view of a portion of the lamp 100, which better illustrates the air flow 200 from the fan element 140 to the heatsink 120. More particularly, the fan element 140 is configured to produce an airflow and direct the airflow 200 towards the heatsink.

The fan element 140 may comprise a fan 141 configured to produce the airflow.

The fan element may comprise a fan housing 142 configured to house the fan; and a fan coupling element 143 configured to couple the fan housing to the coupling element 160. The fan element may further comprise an air intake 145 through which air is drawn by the fan element to produce the airflow.

The airflow 200, as illustrated in FIG. 2, may be drawn through the air intake 145 by the fan element 140. The produced airflow 200 thereby travels to the heatsink 120 and escapes the lamp by an air outlet 170.

As previously mentioned, the lamp 100 comprises a covering element 150 that covers or closes the volume of space surrounded by the heatsink so as to close the volume of space at an end proximate to the fan element. Put another way, the volume of space is capped or blocked with a covering element 150 at an end proximate to the fan element. Thus, the covering element 150 prevents or reduces the amount of the airflow 200 that moves directly from the fan element 140 to the heatsink.

This approach increases the pressure and/or volume of the airflow 200 that moves towards and through the heatsink 120, i.e., as air is not lost through, or otherwise affected by, the volume of space 130. Put another way, more air is able to flow past the heatsink per unit of time. This improves the efficiency of the heatsink 120 and therefore the overall heat dissipation of the lamp 100.

In preferred examples, the covering element 150 is configured to prevent airflow, directed from the fan element, from entering the volume of space at the end proximate to the fan element. Thus, the covering element may effectively hermetically seal the volume of space 130 from the airflow 200 produced by the fan element 140. This significantly increases the pressure and/or amount of air in the airflow from the fan element to and/or through the heatsink 120.

The covering element 150 forces the airflow 200 from the fan element 140 into the gap between the neighboring fins of the heatsink.

The covering element 150 may be integrally formed in an enclosure 155 that defines at least some of the bounds or edges of the volume of space 130. The enclosure 155 may, for instance, form at least part of the heatsink 120 or be coupled/connected to the heatsink 120.

FIG. 3 provides a top-down cross-sectional view of the lamp 100 in the plane B₁-B₂ defined in FIG. 1.

As best illustrated in FIG. 3, the volume of space 130 may be cylindrical, i.e., have a circular cross-section. However, alternative shapes for the volume of space include any regular or irregular prism (e.g., a rectangular prism), such that the cross-sectional shape of the volume of space may be any regular or irregular shape.

The heatsink may be formed as a polygonal prism with a cutout, such that the polygonal prism is configured to surround the volume of space, defined in the cutout.

The heatsink may comprise a plurality of fins 121, e.g., that extend parallel to the axis X. Each fin is a projection or panel for dissipating heat into an airflow. The plurality of fins is preferably positioned in or on the path of the airflow 200 for improved dissipation of heat from the lamp to the outside via the air outlet 170. The plurality of fins may be positioned on an interior of the heatsink, e.g., so as to not be exposed to the volume of space.

Preferably, and as illustrated in FIG. 1, the length In of the heatsink, measured in a direction parallel to the axis X of the volume of space, may be greater than the width Wh of the heatsink, measured in a direction perpendicular to the axis X of the volume of space.

Furthermore, the light emitting element 110 may be configured to be (directly) attached to the heatsink 120. This improves the thermal coupling between the light emitting element 110 and the heatsink 120, to thereby improve the heat dissipation of the lamp 100.

In particular, the light emitting element may be positioned to surround or encircle the heatsink 120 (and therefore the volume of space 130 as well). This prevents or reduces the blocking of any light by the heatsink, thereby providing a more efficient lamp (in terms of increased light output per unit power consumed).

As illustrated in FIG. 1, the lamp 100 may comprise a lamp base 192. The lamp base 192 provides a means for mounting the lamp 100 to a socket (not shown) on a wall, ceiling or any other surface. In some embodiments, the lamp base may comprise a screw cap, a pin and push cap or a bayonet cap. However, embodiments are not restricted to these, and the lamp base 192 may be any means suitable for fitting the lamp 100 to a lamp receiving socket.

The lamp base may be located at a first end 125 of the heatsink 120, with the fan element being located at a second, different end 126 of the heatsink 120. Thus, the second end is opposite to the first end. This approach may be more thermally efficient, particularly when the lamp 100 is coupled to a ceiling, as cooler air will be drawn from the bottom of the lamp (as warm air rises towards the ceiling). This approach will also reduce any recirculation of air previously output by the lamp, further improving heat dissipation of the lamp.

Alternatively, the lamp base 192 and the fan element 140 may be located at a same end of the heatsink, e.g., the first end 125. This approach can reduce an amount of wiring required to drive the fan element 140, and may therefore prove more materially efficient. In this scenario, the air outlet 170 will be positioned at the second end 126 of the heatsink for improved heat dissipation.

The lamp 100 may further comprise a protective envelope 191, as perhaps best exemplified in FIG. 1. The envelope 191 may, for instance, be formed of a transparent or translucent material that ensures illumination from the light emitting element 110 is capable of dissipating or being transmitted to the surroundings. Thus, the envelope may be formed from a transmissive and/or dispersive material. For example, the material of the envelope 191 may be glass or a plastic.

It has been previously mentioned how the fan element 140 may be coupled to the heatsink 120 via a coupling element. More particularly, a coupling element 160 may be coupled to the heatsink. The coupling element 160 may couple to a fan coupling element 143 of the fan element. The coupling between the coupling element 160 and the fan coupling element 143 may be releasable, e.g., to allow for maintenance, removal and/or replacement of the fan element 140.

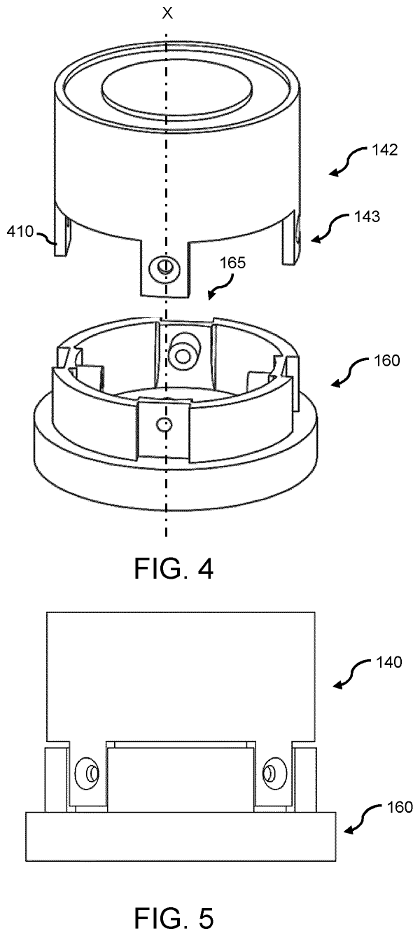

FIG. 4 illustrates a coupling element 160 and a fan coupling element 143 according to some embodiments.

The fan coupling element 143 may comprise one or more protrusions 410 configured to extend towards the heatsink, e.g., along or parallel to axis X. The coupling element 160 may couple to the fan coupling element 143 at each of the one or more protrusions.

In some examples, the coupling element 160 is configured to couple to the fan coupling element 143 via one or more screws or bolts (not shown). Thus, the fan coupling element 143 and the coupling element 160 may each comprise a hole and/or thread through which a screw or bolt can be positioned or located in order to secure the coupling element 160 and the fan coupling element 143 together.

The proposed technique, of using protrusions that extend towards the heatsink, increases the available radius or width for the fan housing 142 with respect to a particular radius/width lamp. In particular, if the fan coupling element 143 instead comprised protrusions that extended radially with respect to the lamp 100, e.g., perpendicular to the axis X, this would necessitate a reduction in the available size of the housing to fit within a same radius of the overall lamp.

FIG. 5 provides a view of an assembled configuration of the coupling element 160 and fan coupling element 143.

This type of assembly allows the use of a fan 141 with a larger diameter for a same size lamp, as previously explained. Use of a fan with a larger diameter can provide a higher rate or pressure of the airflow in the heatsink 120 for a same rotation speed. Alternatively, when the diameter size of the fan 141 is larger, a lower rotating speed of the fan can be used to provide the same airflow as previously available, resulting in an advantageous noise reduction.

Alternatively, the proposed assembly can allow for the overall width/radius of the lamp 100 to be decreased (compared to a lamp with a fan coupling element having radially extending protrusions) for a same size fan 141.

Referring back to FIG. 2, a gap 250 may be formed between the light emitting element 110 and the protective envelope 191. This gap 250 may, for instance, defined an optical space or volume that allows for spreading of light output by the light emitting element 110 before becoming incident upon the protective envelope 191 (e.g., which may then scatter the light).

In some examples, the lamp 100 may comprise a second covering element 255. The second covering element 255 may be configured to cover the gap 250 so as to close the gap 250 (or optical space) at an end proximate to the fan element 140. Put another way, the optical space defined by the gap 250 may be capped or blocked with a second covering element 255 at an end proximate to the fan element 140. Thus, the second covering element 255 prevents or reduces the amount of the airflow 200 that moves directly from the fan element 140 and into the optical space or gap 250.

This approach further increases the pressure and/or volume of the airflow 200 that moves towards and through the heatsink 120, i.e., as air is not lost through, or otherwise affected by, the gap 250. Put another way, more air is able to flow pas the heatsink per unit of time. This improves the efficiency of the heatsink 120 and therefore the overall heat dissipation of the lamp 100.

In preferred examples, the second covering element 255 is configured to prevent airflow 200, directed from the fan element 140, from entering the gap 250 at the end proximate to the fan element 140. Thus, the second covering element 255 may effectively hermetically seal the gap 250 from the airflow 200 produced by the fan element 140. This significantly increases the pressure and/or amount of air in the airflow from the fan element to and/or through the heatsink 120. Another advantage of the second covering element 255 is in a significant reduction in dust accumulation in the gap 250, e.g., caused by dust carried by the airflow. This can reduce any dust accumulation on the optical elements, thereby reducing optical efficiency degradation.

As illustrated in FIG. 2, the second covering element 255 may be formed as part of the coupling element 160, e.g., integrally formed therewith. Alternatively, the second covering element may be a dedicated element that covers the gap 250, e.g., is coupled between the light emitting element 110 and the protective envelope 191.

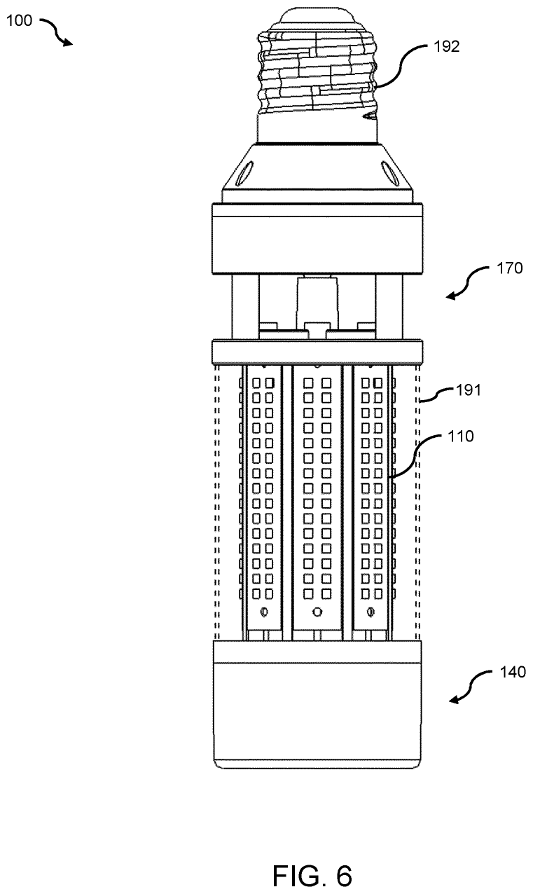

FIG. 6 provides another view of the lamp 100, assembled as described above and as exemplified in FIG. 1.

This view perhaps best illustrates the envelope 191 that surrounds the light emitting element 110, as well as the preferred positional relationship between the fan element 140 and the lamp base 192.

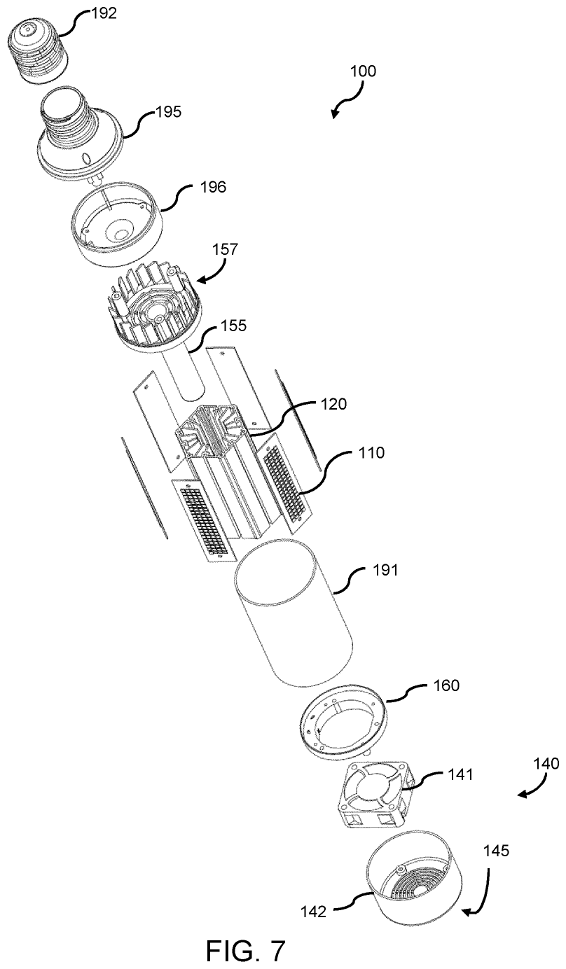

FIG. 7 provides an exploded view of a lamp 100 according to an embodiment.

The lamp 100 as shown in FIG. 7 comprises a fan element 140, a coupling element 160, a heatsink 120, a light emitting element 110, a protective envelope 191 and a lamp base 192. The fan element 140 further comprises a fan 141 and a fan housing 142. An air intake 145 is also defined.

As described above, the lamp base 192 is configured for mounting the lamp 100 to a socket. In some specific embodiments, the lamp base may be a screw end cap. Alternatively, the lamp base may be a pin and push cap or a bayonet cap. However, embodiments are not restricted to these, and the lamp base 192 may be any means suitable for fitting the lamp 100 to a lamp receiving socket.

Furthermore, the lamp base 192 may be coupled to a mount 195.

In some specific embodiments, the mount 195 of the lamp 100 may be a driver housing comprising a driver. In this embodiment, the driver is not positioned within the heatsink 120 and/or the envelope 191, but is rather positioned as an independent compartment of the overall lamp assembly. Such assemblies enable the use of high-power lamp while enabling a larger diameter for the heatsink 120, hence further enabling a better heat dissipation while keeper a smaller lamp diameter.

The mount 195 may be further coupled to a supporting element 196. In some specific embodiment, the supporting element is a connecting part configured to connect the driver to the light emitting element.

FIG. 7 also illustrates an air outlet arrangement 157 that defines the one or more air outlets, e.g., the shape and/or position of the one or more air outlets. The airflow may therefore pass from the heatsink to the air outlet arrangement and thereafter escape the lamp 100. The air outlet arrangement 157 may be integrally formed with the enclosure 155 that surrounds or bounds the volume of space.

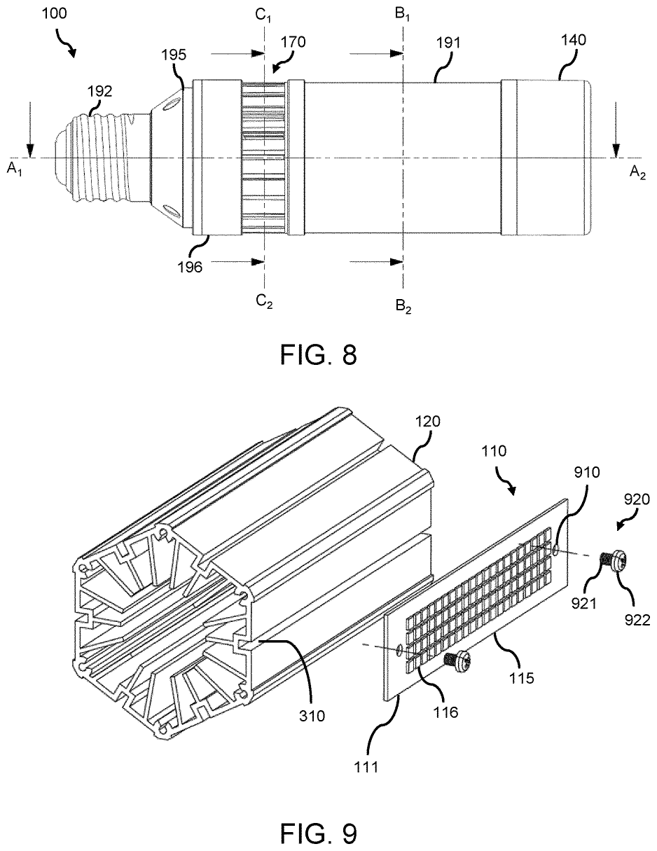

FIG. 8 provides an external view of a lamp 100 according to an embodiment. FIG. 8 demonstrates various elements of the lamp 100 that are externally visible, including the lamp base 192, the mount 195, the supporting element 196, the air outlet 170, the protective envelope 191 and the fan element 140.

FIG. 8 also illustrates a number of planes through which cross-sections have been taken for other Figures of this disclosure. In particular, FIG. 1 is a cross-sectional view taken in a plane A₁-A₂ illustrated in FIG. 8. Similarly, FIG. 3 is a cross-sectional view taken in a plane B₁-B₂ illustrated in FIG. 8.

Turning back to FIG. 3, a further optional feature of an embodiment is illustrated and hereafter described.

In particular, the heatsink 120 comprises at least one recess or groove 310. Each recess or groove is formed in a side wall of the heatsink 120. Each recess or groove may therefore be formed by an indentation of the side wall of the heatsink 120 towards the volume of space 130 surrounded by the heatsink. The depth of each recess is preferably greater than the thickness of the side wall of the heatsink.

The light emitting element 110 is configured to at least partially cover the recesse(es) and/or groove(s) 310. In the illustrated example, the light emitting element 110 is formed of a one or more discrete light emitting modules 111, here: a plurality of light emitting modules. Each light emitting module is formed from a support 115 and a plurality of light emitting devices 116, such as LEDs. Each light emitting module is positioned to cover a portion of a different recess or groove 310 formed in the heatsink 120.

This approach advantageously allows for thermal expansion of the heatsink and/or light emitting element, reducing a risk of damage to the heatsink or light emitting element.

In some advantageous embodiments, the light emitting element 110 is coupled to the heatsink 120 via the at least one recess or groove. For instance, the light emitting element 110 may be secured to the heatsink by connecting means (i.e., one or more connecting elements) that engage with the at least recess or groove so as to secure the light emitting element 110 to the heatsink 120. Examples of suitable connecting means include one or more screws or bolts that engage with the recess or groove 310.

FIG. 9 provides a perspective view illustrating one approach for coupling the light emitting element 110 to the heatsink 120 via a recess or groove 310 of the heatsink. The light emitting element 110 comprises at least one hole 910 through which a thread 921 of a respective screw 920 may be passed, with the head 922 of the respective screw abutting or engaging with the perimeter of the hole. Specifically, each hole 910 may be located in a support 115 of a light emitting module 111. The thread can be screwed into the recess or groove to thereby couple the light emitting element to the heatsink. In preferred examples, each screw 920 is a self-tightening screw.

This approach provides a simple mechanism for coupling the light emitting element to the heatsink.

In the illustrated example, the light emitting element is again formed from a plurality of separate light emitting modules 111, each of which is secured to a respective recess or groove of the heatsink by a set of one or more (here: two) screws or other coupling elements. Only one of the light emitting modules 111 is illustrated in FIG. 9 for illustrative clarity.

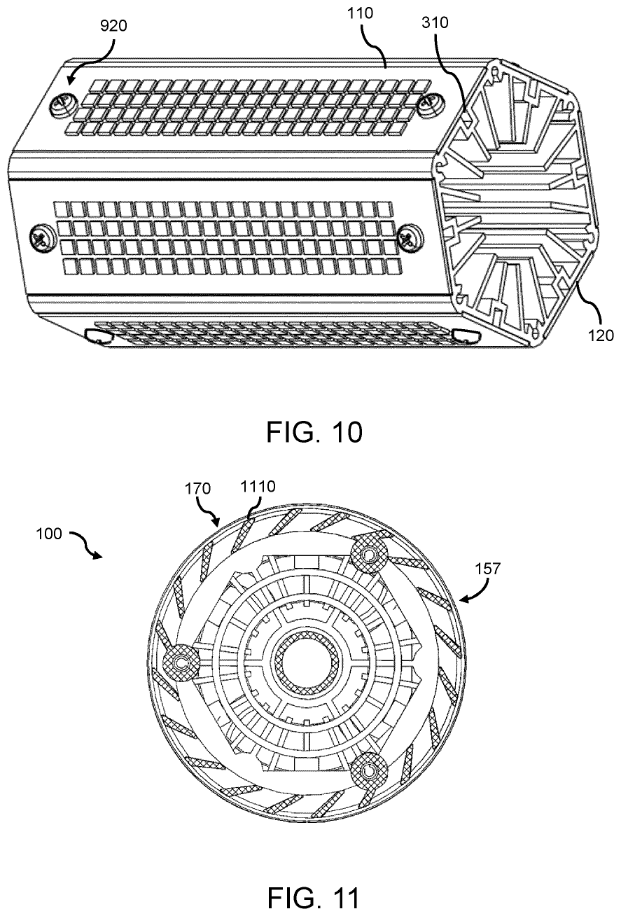

FIG. 10 provides a view of the light emitting element 110 and the heatsink 120 when they have been assembled using a screw-based approach previously described.

Turning back to FIG. 3, in some examples, at least one fin 121 is coupled to the groove 310 formed in the heatsink. This improves the heat dissipation from the light emitting element 110 coupled to cover the groove 310.

A further advantage to the use of a recess or groove is that it enables the wall thickness of the heatsink 120 to change more smoothly, while also allowing thermal expansion.

In some advantageous examples, the heatsink 120 and any support 115 of the light emitting element 110 may be formed from the same material, resulting into the same thermal expansion. Therefore, due to the one or more recesses/grooves, the thermal expansion difference between the heatsink 120 and the light emitting element 110 is significantly reduced or minimized, resulting into minor to no mechanical stress caused by thermal expansion.

The lamp 100 as described in the present disclosure may be used as an LED lamp having a small size and high lumen output for use in any kind of luminaire. By way of example, the lamp may have an output luminous flux of no less than 10,000 lm, or no less than 20,000 lm. The skilled person would be readily capable of constructing the light emitting element 110 and/or the light envelope to achieve this goal.

FIG. 11 is a cross-sectional view taken in a plane C1-C2 illustrated in FIG. 8.

FIG. 11 illustrates an arrangement for an air outlet arrangement 157 that provides one or more air outlets from which air is able to escape from the lamp 100. The air outlet arrangement comprises a plurality of baffles 1110 that define one or more air outlets 170. Each baffle may be angled with respect to a radial direction of the overall lamp.

Variations to the disclosed embodiments may be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A lamp comprising:
a light emitting element;
a heatsink thermally coupled to the light emitting element and configured to surround a volume of space;
a fan element configured to produce an airflow and direct the airflow towards the heatsink;
a covering element configured to cover the volume of space surrounded by the heatsink so as to close the volume of space at an end proximate to the fan element; and
a coupling element configured to couple the fan element to the heatsink;
wherein the fan element comprises:
a fan configured to produce the airflow;
a fan housing configured to house the fan; and
a fan coupling element configured to couple the fan housing to the coupling element;
wherein:
the fan coupling element comprises one or more protrusions configured to extend towards the heatsink along an axis (X) of the volume of space; and
the coupling element is configured to couple to the fan coupling element at each of the one or more protrusions.

2. The lamp of claim 1, wherein the volume of space is cylindrical.

3. The lamp of claim 2, wherein the heatsink comprises an polygon cylinder configured to surround the volume of space.

4. The lamp of claim 3, wherein the heatsink further comprises a plurality of fins, for dissipating heat into the airflow, that extend along an interior of the annular cylinder.

5. The lamp of claim 1, wherein the covering element is configured to prevent airflow, directed from the fan element, from entering the volume of space at the end proximate to the fan element.

6. The lamp of claim 1, wherein the coupling element is configured to couple to the fan coupling element via one or more screws or bolts.

7. The lamp of claim 1, further comprising an air outlet from which the airflow, produced by the fan element, escapes the lamp, wherein the heatsink is positioned between the air outlet and the fan element.

8. The lamp of claim 1, wherein:
the heatsink is configured to surround an axis (X) of the volume of space; and
the length of the heatsink, measured in a direction parallel to the axis of the volume of space, is greater than the width of the heatsink, measured in a direction perpendicular to the axis of the volume of space.

9. The lamp of claim 1, wherein:
the heatsink comprises at least one recess; and
the light emitting element is coupled to the heatsink so as to cover at least a portion of the at least one recess.

10. The lamp of claim 1, wherein the fan element comprises an air intake through which air is drawn by the fan element to produce the airflow.

11. The lamp of claim 1, wherein the light emitting element is configured to attach to the heatsink.

12. The lamp of claim 1, further comprising a lamp base for mounting the lamp to a socket, wherein:
the lamp base is located at a first end of the heatsink; and
the fan element is located at a second end of the heatsink, wherein the second end is opposite to the first end.
